(19) United States
(12) Patent Application Publication
(10) Pub. No.: US 2025/0069158 A1
(43) Pub. Date: Feb. 27, 2025

(54) SYSTEMS, DEVICES, AND METHODS FOR SPOILER CONTENT TRANSMISSION IN USER-GENERATED CONTENT SYSTEMS

(71) Applicant: 14979419 Canada Inc., Brampton (CA)

(72) Inventor: Jashan Puniya, Brampton (CA)

(21) Appl. No.: 18/813,216

(22) Filed: Aug. 23, 2024

Related U.S. Application Data
(60) Provisional application No. 63/534,655, filed on Aug. 25, 2023.

(51) Int. Cl. G06Q 50/00

(52) U.S. Cl. CPC G06Q 50/01

(57) ABSTRACT

A computer-implemented system for spoiler blocking is provided. The system includes a story map engine configured to define at least one data structure representing at least one keyword, a tagging engine configured to associate at least one tag with at least one content, and a spoiler blocker configured to prevent at least one content tagged with at least one spoiler from being presented to a user, using the at least one data structure.

### FIELD

The present specification relates generally to computer platforms, and, specifically, to online tagging systems.

### BACKGROUND

Users browsing online or social media run the risk of encountering spoiler content (“spoilers”) on narrative-based media (NBM). Some web browsers and mobile phone applications have implemented spoiler tags as part of the user interface, which users may rely on. However, these existing tags tend to contain little to no information beyond the words, “spoiler”, and as a result, the use of these tags are binary in nature. A second method involves the use of the words, “spoiler warning” or words relating to particular attributes of the narrative-based media content; for example, the season and episode number of a TV show. However, such manual entries are not parseable or individually blockable. Further, where a creator adds a notice of a spoiler to a title or caption, a viewer is not actually prevented from already viewing the spoiler and spoilers can be delivered without warning (e.g., via thumbnails in a recommended list). A third method involves the user adding all potential keywords to a “blocked” list, however, this method is time consuming and the user risks missing out on content that may not include spoilers and consequently, may experience lower social media engagement. Further, these existing tags do not forewarn users that a post may contain spoilers. In addition, these methods do not allow users to view the blocked content even after they have seen the relevant media. Instead, that content has disappeared from the feed and cannot be revisited.

Accordingly, users can stop or reduce online or social media usage when anticipated narrative-based media is being released. For example, this can be where a NBM has enough critical-mass to take over social media feeds (e.g., blockbuster movies). In many of these cases, users avoid spoilers but still miss out on initial reactions and are left out of those social interactions.

Another option for users is to risk viewing spoilers by continuing to engage socially/browse and decide to risk spoilers ruining the story. In this case, users can engage in the social interactions, but the media experience is ruined if the user sees a spoiler. It is a negative experience, and it happens because users are forced to make a tradeoff between social interactions and enjoying the story without spoilers.

### SUMMARY

In some embodiments, there is provided a computer-implemented system for spoiler blocking, the system comprising: story map engine configured to define at least one data structure representing at least one keyword; tagging engine configured to associate at least one tag with at least one content; and spoiler blocker configured to prevent at least one content tagged with at least one spoiler from being presented to a user, using the at least one data structure.

In some embodiments, there is provided a system of identifying and filtering spoilers from narrative-based media, comprising a hierarchy unit, a validation unit, a spoiler storage unit and a recommendation feed unit; and a method of identifying and filtering spoilers from narrative-based media, comprising of a series of steps, including, adding a primary tag to narrative-based media data by a first user, adding a secondary tag to narrative-based media data by a second user, validating the narrative-based media data associated with a secondary tag and organizing the primary tags and secondary tags into a hierarchy.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects, and in which:

FIG. 1 is a schematic of a hierarchy organizing spoiler keywords, according to an embodiment;

FIG. 2 is a schematic showing a side-by-side comparison of unstructured tagging and structured tagging, according to an embodiment;

FIG. 3 is a schematic showing how spoiler user-generated content is delivered to other user's feeds, according to an embodiment;

FIG. 4 is a schematic showing a process of generating a user's recommendation feed, according to an embodiment;

FIG. 5 is a schematic showing the hierarchy organizing spoiler keywords as it relates to a validation process, according to an embodiment;

FIG. 6 is a schematic showing three sub-processes of the validation process, according to an embodiment;

FIG. 7 is a schematic showing one of the three sub-processes of the validation process, according to an embodiment;

FIG. 8 is a schematic showing one of the three sub-processes of the validation process, according to an embodiment;

FIG. 9 is a schematic showing one of the three sub-processes of the validation process, according to an embodiment;

FIG. 10 is a schematic view depicting secondary validation; and

FIG. 11 is a schematic view of an example spoiler blocking platform, according to some embodiments.

### DETAILED DESCRIPTION OF EMBODIMENTS

The description that follows, and the embodiments described therein, are provided by way of illustration of an example, or examples, of particular embodiments. These examples are provided for the purposes of explanation, and not of limitation. In the description, like parts are marked throughout the specification and the drawings with the same respective reference numerals. The drawings are not necessarily to scale and in some instances, proportions may have been exaggerated in order more clearly to depict certain features.

In some embodiments, spoiler blocking platform 100 is configured to block spoilers from being presented to users when accessing content and subsequently facilitate the transmission of content containing spoilers (e.g., after the user has viewed the associated media) so users can engage in content they previously missed.

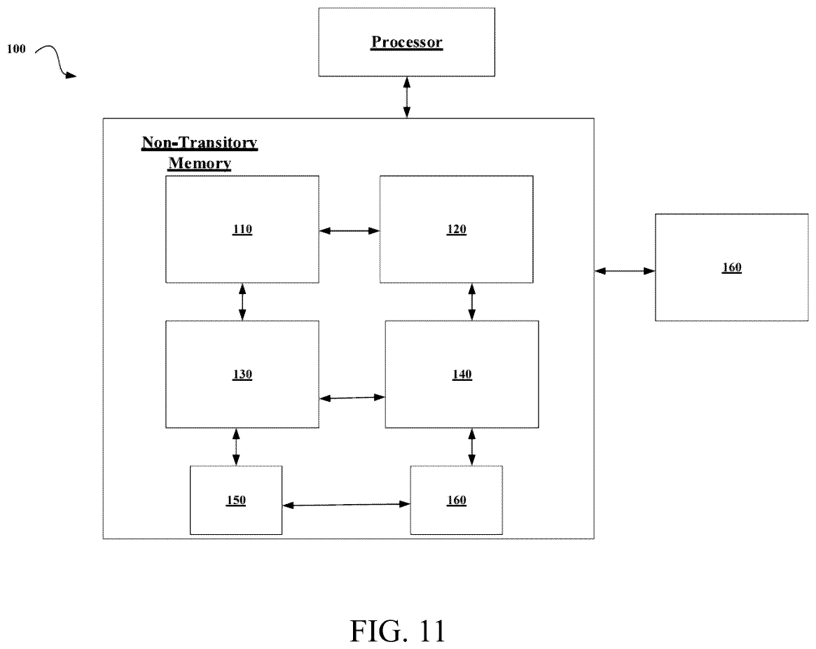

FIG. 11 is a schematic view of an example spoiler blocking platform 100 according to some embodiments. In some embodiments, spoiler blocking platform 100 includes one or more processing devices and one or more storage devices. Each component of spoiler blocking platform 100 can be implemented by more than one processor or node, and references to a singular processing device or other component can be more than one of same in some embodiments.

In some embodiments, spoiler blocking platform 100 includes story map engine 110, tagging engine 120, spoiler blocker 130, seen tracker 140, recommendation engine 150, and validation engine 160. A processing device of spoiler blocking platform 100 is configured to execute instructions in memory to configure story map engine 110, tagging engine 120, spoiler blocker 130, seen tracker 140, recommendation engine 150, and validation engine 160. A computing device 160, such as a mobile device running a mobile application or a remote server, is configured to connect with spoiler blocking platform 100 and allow for user engagement, for example, where spoiler blocking platform 100 is implemented as a Chrome plug-in, an app, or an integrated feature on a social media platform (e.g., web- or app-based). Computing device 170 is configured to present a display generated by spoiler blocking platform 100, according to some embodiments.

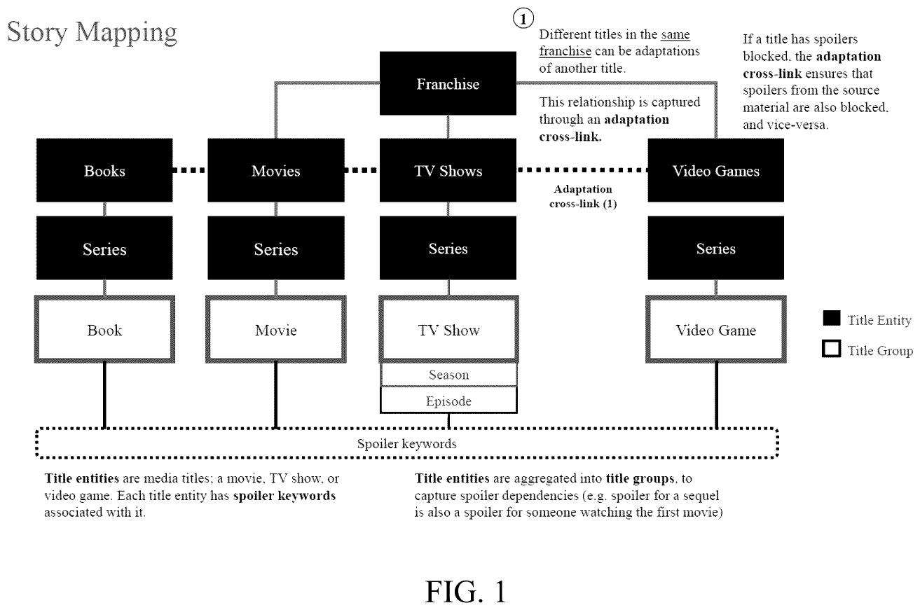

In some embodiments, story map engine 110 is configured to define at least one data structure storing data representing keywords, such as title entities, title groups, and/or name entities. The data structure(s) can be a map data structure, for example. Title entities are associated with attributes and associated name entities. In some embodiments, name entities are associated with attributes (e.g., akas) and media appearance(s) (e.g., in list format). In some embodiments, title entities are media titles with attributes and associated name entities, while name entities are names such as characters, cast, and/or crew associated with a title entity. Some name entities have alternate names which are stored in the data structure(s). Keywords include name entities and title entities. Keywords can be used by spoiler blocking platform 100 to determine one or more spoilers. In some embodiments, story map engine 110 is configured to map media narratives across a time-series based structure. For example, release dates for media, franchise linking, and/or other types of associations are defined by story map engine 110. For example, story map engine 110 can be configured to store associations between different title entities, name entities, and title groups such as shown in FIG. 1, according to time, category, type of media, series, other categorization, and/or other dependency(ies).

In some embodiments, the data structure (e.g., map) is created by aggregating titles using online data sources. Titles are categorized by story map engine 110 into the data structure (series, franchises, adaptations, etc.). The data structure contents can then be validated by data input (e.g., humans).

The data structure is updated by continuously scraping external data sources (e.g., Internet) as new titles are released. The data structure does not require frequent updates, as unreleased titles that are under a year from release can also have the necessary data extracted—there is significant lead time for content inclusion in the data structure, and users can block spoilers for titles that haven't been released yet (e.g., trailers, casting information).

In some embodiments, tagging engine 120 is configured to receive data representing a tag and associate the tag data with one or more contents, such as online post(s), video(s), article(s), and/or other media. For example, a creator user of spoiler blocking platform 100 can tag a post (they create) related to narrative-based media (e.g., TV episode, TV series, etc.) that the user has seen or otherwise experienced.

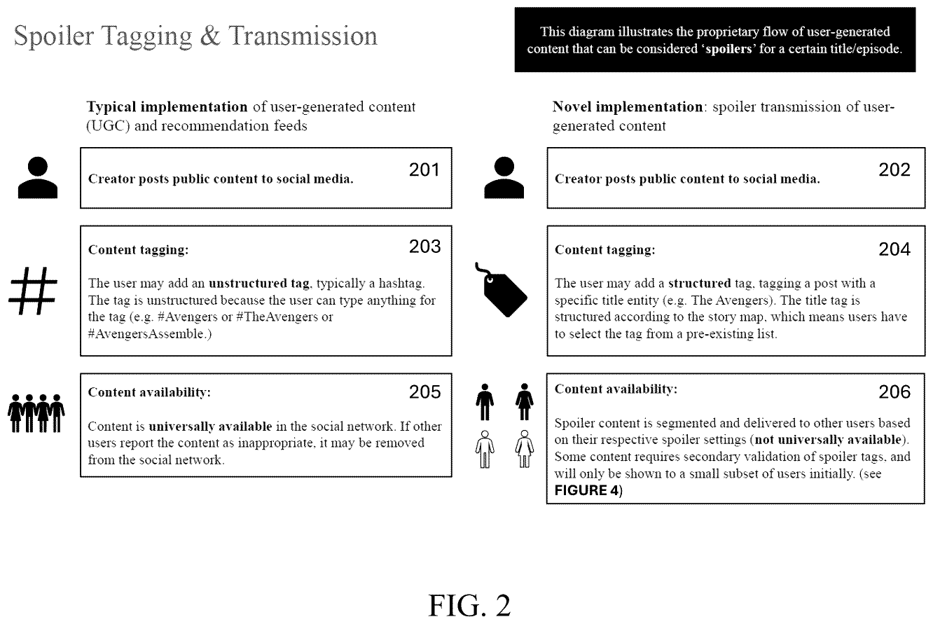

Whether tagging is structured or unstructured affects availability of spoiler content to the public. In FIG. 2, a side-by-side comparison is depicted to show the distinctions between structured and unstructured tagging. In either case, a creator posts public content to social media 201, 202. With unstructured tagging, after positing public content 201, the user may create a tag (typically a hashtag) and include the user-created tag in the caption or metadata of the post 203. Because this tag is user-created, the tag may be whatever the user types. This is considered an ‘unstructured tag.’ Unstructured tags are universally available in a social network 205. If other users report the content with an unstructured tag, content with the tag may be removed from the social network.

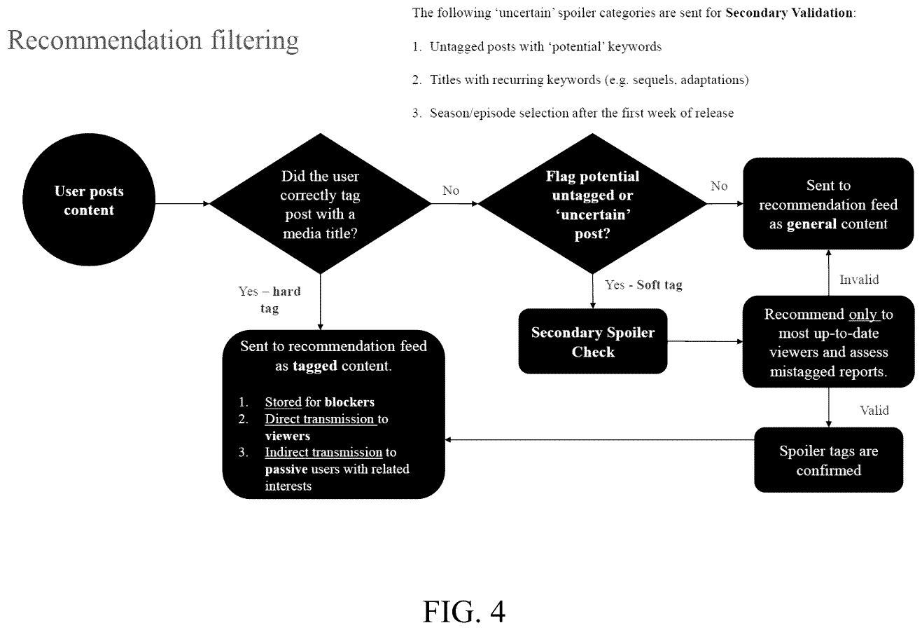

With structured tagging, after positing public content 202, the user may select a tag from a collection of available tags 204 instead of creating their own tag. The collection of available tags, for example, may be in a dropdown menu from which the user may click to select one or more tags. Because the tags come from a pre-existing list, this is considered a ‘structured tag.’ Spoiler content is segmented and delivered to other users based on the other users' respective spoiler settings 206. Notably, some content requires secondary validation of spoiler tags and will only be shown to a small subset of users based on filtering, which is further described below with respect to FIG. 4.

In some embodiments, seen tracker 140 is configured to receive data representing media marked as seen (or experienced, etc.) by a user. The media can be a title group, title entity, name entity, and/or keyword, for example, such as defined by story map engine 110. For example, the user can select or denote media that is marked as blocked media for that user. Seen tracker 140 is configured to mark (e.g., and store) the media as seen, according to some embodiments. Seen tracker 140 is configured to provide or allow to be provided any previously blocked content (e.g., posts, videos, articles) related to the media to the user. Recommendation engine 150 is configured to present or allow to be presented content to a user based on media marked as seen by seen tracker 140 for that user, according to some embodiments. This can enable transmission of previously blocked spoilers to the user after the user has seen the media.

In some embodiments, recommendation engine 150 is configured to manage at least one recommendation presented to at least one user. For example, recommendation engine is configured to present or allow to be presented content (e.g., posts, articles, videos, media, etc.) to a user that matches the user's viewing schedule. A user can configure their viewing schedule in relation to keywords defined by story map engine 110, such as a title group, title entity, or name entity, for example. For example, the user can configure their viewing schedule for a particular TV show season and, separately, for a particular movie series. In some embodiments, recommendation engine 150 is configured to prevent content tagged with one or more spoilers related to blocked media for that user from being presented to that user. For example, in some embodiments, spoiler blocker 130 is configured to receive a request from a user to block content tagged with a particular title entity defined by story map engine 110, prevent any such content or any content tagged with a related or dependent tag (as defined by story map engine 110), and/or transmit data representing same to recommendation engine 150. Recommendation engine 150 is then configured to prevent content tagged with the blocked keyword (e.g., title entity, title group, name entity, etc.) from being presented to the user.

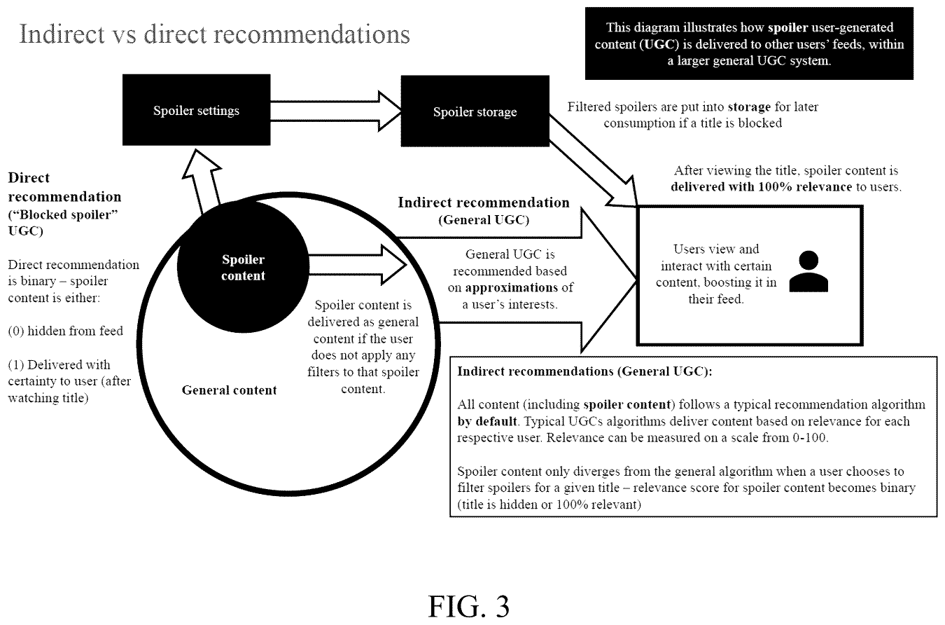

As shown in FIG. 3, spoiler user-generated content (UGC) is delivered to other users' feeds, within a larger general UGC system. With indirect recommendations, all content (including spoiler content) follows a typical recommendation algorithm by default, using a relevance score from 0-100 to recommend content that matches a user's interests. Spoiler content only diverges from general UGC when a user chooses to filter spoilers for that title. When a user filters spoilers for a given title, the relevance score becomes binary. When a title is blocked, the relevance of spoiler content for that title is 0 and the post will be restricted from the user's feed. Once the title is marked as watched, the relevance is turned to 100% and all previously-held spoiler content is delivered to the user's feed.

With direct recommendations, on the other hand, spoiler content may be recommended if the user is passive toward the title (i.e., no intent to filter the content). Filtered spoilers are put into storage for later consumption if a title is blocked. After viewing the title, spoiler content is directly delivered to the users.

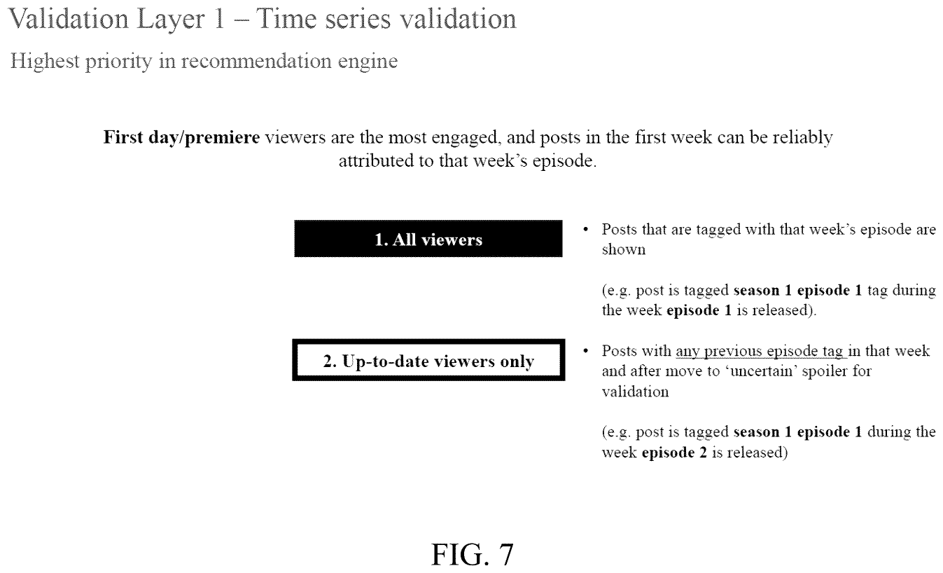

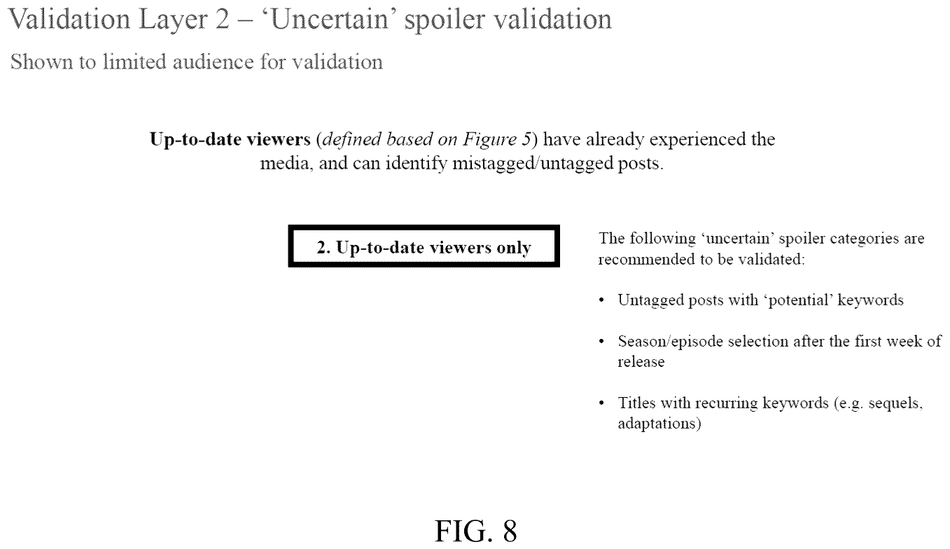

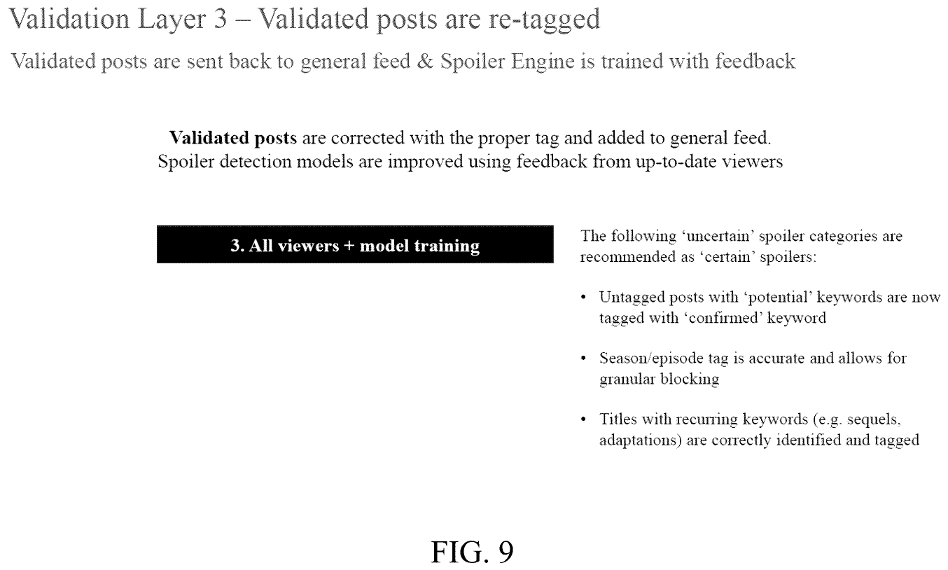

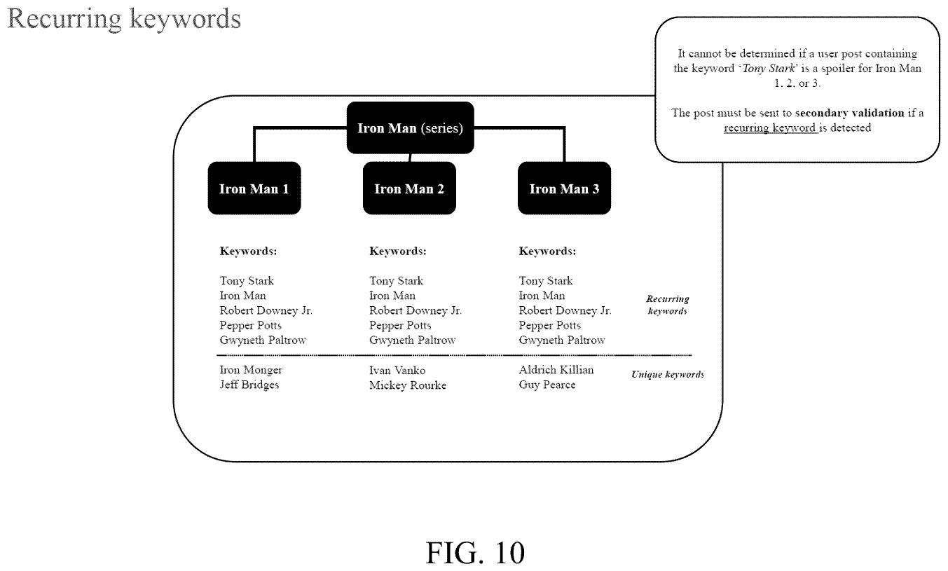

In some embodiments, validation engine 160 is configured to implement secondary validation for spoiler categories as shown in FIG. 4. Content that is not tagged or that could be mis-tagged or where a spoiler category is uncertain is presented to at least one user (e.g., as a recommendation). Validation engine 160 is configured to select those users for presentation that are above a threshold for being up-to-date on having seen the associated media, as determined using seen tracker 140. Those user(s) are shown a request to tag or categorize the content, such as using one or more keywords derived from data defined by story map engine 110. Examples of such content include untagged posts with potential keywords, season/episode selection after the first week of release, and adaptations (e.g., manga to anime, movie to game, etc.) or titles with recurring keywords (e.g., sequels, adaptations). In some embodiments, users can only tag a single title entity for a given content (e.g., post), and the keywords are presented simply to suggest the title that can be tagged. Such tag or categorization is used to define the data structure(s) defined by story map engine 110. Example validation processes are shown in FIGS. 4, 5, and 6, according to some embodiments. In some embodiments, validation engine 160 is configured to train natural language processing using the feedback from the user(s) for future spoiler detection in content. User(s) are selected for presentation of the content for validation according to priority, the priority defined based on time-series, up-to-date viewers, and/or users who have previously successfully identified mis-tags, according to some embodiments. Example validation processes are shown in FIGS. 7, 8, and 9. FIG. 10 shows an example process for secondary validation. For example, validation engine 160 is configured to send content to secondary validation if a recurring keyword is detected, such as where the same actor names are associated with different media (e.g., movies in a series). One or more unique keywords are used by validation engine 160 to determine which media the content is associated with.

In some embodiments, story map engine 110 is configured to define a story mapping data structure for capturing spoilers by tracking and protecting narrative-based experiences and implementing spoiler recognition using keywords and aggregating them into a story hierarchy.

In some embodiments, spoiler blocking platform 100 is configured to implement one-click spoiler tag and blocking (both align to same story mapping structure).

In some embodiments, spoiler blocking platform 100 is configured to implement secondary validation using the story map engine 110 integrated into the recommendation engine 150.

In some embodiments, spoiler blocking platform 100 is configured to implement spoiler storage as a method of matching asynchronous viewing on any timeline, organized as per the story hierarchy. In some embodiments, users can see the same spoiler content based on their own asynchronous viewing schedule (many users do not watch the same media at the same time). For example, a spoiler post made on April 1 could be shown to a user on April 3, and another user on April 4, based on their spoiler blocker settings configuration. The spoiler storage system is configured to generate the recommendation feed tailored to a user's viewing habits, by presenting the same content to users on an asynchronous timeline that matches the asynchronous viewing schedules of users, which is configurable by the user. The spoiler storage system is based on the story map engine 110, as the user is selecting which ‘stories’ to block (e.g., series-level spoiler block or individual), and then subsequently release for viewing by the user (spoiler transmission).

In some embodiments, spoiler blocking platform 100 is configured to implement a one-click spoiler blocker as a streamlined, user-friendly way to avoid spoilers-users simply select a media they want to avoid spoilers for, and the story map engine 110 is configured to determine all the keywords that need to be blocked when browsing/posting content, for example, on social media.

In some embodiments, spoiler blocking platform 100 is configured to be integrated into a social media platform that allows for safely browsing feeds/messages, with a recommendation system that matches users' asynchronous consumption of narrative-based media. The spoiler posts are only shown after the spoiler is tagged as ‘seen’-users can engage in the initial reactions/social interactions and catch up on their own schedule. It also allows for a longer tail for consumption of media, and users can engage with others who watch on a similar schedule.

In some embodiments, the data structure(s) defined by story map engine 110 is a comprehensive mapping of all keywords based on the stories a media is connected to (e.g. sequels, prequels, adaptations). Users can select the stories that they are anticipating on a series-level and story map engine 110 is configured, using the data structure(s), to identify and block spoilers accordingly. This is much more granular spoiler blocking compared to current technology, which uses binary spoiler tags.

The one-click spoiler block allows blocks from episode-level all the way to series-level with one click, according to some embodiments. Spoiler blocking platform 100 provides a method for navigating narratives, according to some embodiments. Relationships in franchises are fully captured—for example a block for The Last of Us TV show would also block The Last of Us video game, as it's a 1:1 adaptation. Based on that connection, the story map engine 110 can be used to block the sequel video game TLOU Part II, as it would contain future spoilers for the TV adaptation.

In some embodiments, spoiler blocking platform 100 is configured to provide a spoiler storage system that aligns recommendation engines to match users' asynchronous viewing habits, following the data structure(s) defined by story map engine 110, according to some embodiments.

Example embodiments of spoiler blocking platform 100 will now be described.

According to an embodiment shown in FIG. 1, spoiler blocking platform 100 includes a hierarchy data structure, also referred to as a story map, defined by story map engine 110, where the story map defines associations between potential keywords from narrative-based media content that may represent spoilers. The names, titles and other identifying attributes of narrative-based media are used as keywords to indicate spoilers. Narrative-based media include TV shows, movies, books, single-player games and campaigns in multiplayer games. Each potential keyword may be a title entity or sub-title entity or a name entity. Title entity is a specific piece of narrative-based media; for example, a movie, video game, book or TV show. Title entities may be standalone (e.g. Fight Club), belong to only a series (e.g. Rambo), or belong to a series and franchise (e.g. Iron Man). The seasons and episodes of a TV show are examples of sub-title entities. Title group is an aggregation of title entities at a series and/or franchise level, which is designed to capture the relationship between various narrative-based media. For example, “Avengers: Endgame” and “Avengers: Infinity War” are title entities, both of which are subsets of the title group, “Marvel Cinematic Universe”. Title entities may be associated with additional name entities. A name entity may be comprised of several akas (i.e., also-known-as), which refer to the nicknames of the given actor and/or character in the name entity. For example, Tony Stark is the character name for Robert Downey Jr, but is also known as Iron Man in the movie. Robert Downey Jr. is also commonly known as RDJ. In this case, nicknames for both the actor and character are captured in akas. For example, (actorName=“Robert Downey Jr.”, characterName=“Tony Stark”, akas=“Iron Man”, “RDJ”). The data structure uses characters from narrative-based media as the starting point for identifying and capturing additional spoiler keywords. In sum, the data structure stores both character and non-character related words. Additionally, the data structure can also capture the relationship between different media types in the same franchise. For example, keywords relating to the TV show, The Last of Us, would also be related to keywords relating to the video game, The Last of Us. Further, according to an embodiment shown in FIG. 1, the data structure defines media narratives across a time series-based structure. A time series-based structure refers to the capturing of the relationship between media titles in terms of their release dates within the respective series and/or franchises, in order to fully capture all spoiler dependencies. For example, Iron Man 2 was released after Iron Man 1, and is therefore captured as a sequel in the Story Map. If a user blocks content tagged with Iron Man 2, the spoiler blocker 130 determines that the user has seen the first Iron Man, so Iron Man 1 is left unblocked. Conversely, if a user blocks Iron Man 1, spoiler blocker 130 is configured to determine that the user has not seen Iron Man 2 and Iron Man 3, and therefore, both sequels of which will be blocked. If a user chooses to block the Marvel Cinematic Universe franchise, the spoiler blocker 130 is configured to block content tagged with Iron Man 3 or Avengers. The spoiler blocker 130 is configured to block content based on all spoiler dependencies of a series, and recommendation engine 150 is configured to prevent such blocked content from being presented in generating the recommendation feed unit.

According to an embodiment shown in FIG. 2, keywords that indicate potential spoilers are captured by way of tagging. There can be different types of users for spoiler blocking platform 100, including Creators; Blockers, who are users who have blocked a certain title entity and/or title group, and consequently, are not recommended tagged content; Viewers, who are users who have tagged a title entity from the blocked list as seen and consequently, receive the previously blocked posts directly in their recommendation feed; and Passive, who are general users who have not seen a title entity or blocked it. They can be recommended content by recommendation engine 150 from a non-blocked title, which can be a spoiler. Creators are users who create posts containing narrative-based media content. Creators may choose to tag posts which contain specific spoilers. In the event that the post is not tagged, but keywords are detected, a tag prompt will be presented to prompt the Creator to add the tag to the post before the post is published. Tagged keywords are either title entities or sub-title entities or name entities. Title entities are further organized into title groups within the hierarchy module. Users may then block any title entity or title group, selecting the narrative-based media content which they want to protect. Consequently, the recommendation feed of users will not contain any spoilers relating to the selected narrative-based media content. Creators can only tag title entities, which are then aggregated into title groups through the hierarchy module. Users may select spoiler blocks at the title entity or title group level using one-click. For example, users can select the stories that they are anticipating on a series-level and the system will identify and block spoilers accordingly.

According to an embodiment shown in FIG. 4, the configuration of the recommendation feed unit by recommendation engine 150 occurs via a series of steps. If the user hard tags the post with relevant media (i.e., user generated content), then the post will appear on the recommendation feed as tagged content; that is, for blockers, the content will appear as blocked (relevance=0); for viewers, the content will appear as a hard recommendation (relevance=100); and for passive users with related interests, it will appear as a soft recommendation (relevance between 0-100). For example, a user that engages with Iron Man-tagged posts may enjoy Avengers (based on the franchise as a related interest), or even Batman-tagged posts (based on other users with similar interests in comic book movies). Passive users are served soft recommendations, as they have no direct relation to the tagged media that is suggested in their feed. Conversely, a post that is tagged and matches the user's spoiler selections is directly known to be an interest of the user. For example, a soft recommendation is generated based on machine learning that is configured to generate a prediction of suitable recommendation(s) for a user based on the interests of the user, which can be based on the viewing or spoiler blocking or other behaviour of other similar users. A hard recommendation is based on each individual user's interest(s). No algorithm is needed to determine a user will be interested in Iron Man content if a user has blocked the movie and then unblocked it as a viewer. That is known as a “hard recommendation”, as the social media content is directly served based on the narrative-based media that the user indicated as ‘viewed’. If the user does not tag the post with relevant media (i.e., user generated content), and the validation engine 160 is configured to flag potential untagged or mistagged post with a soft tag, and subsequently, the content will proceed to secondary spoiler check (i.e., a validation process). Once the validation process is complete, the content will only be recommended to most up-to-date viewers. If validation engine 160 does not flag potential untagged or mistagged post, then the content will be sent to a user's recommendation feed as general content.

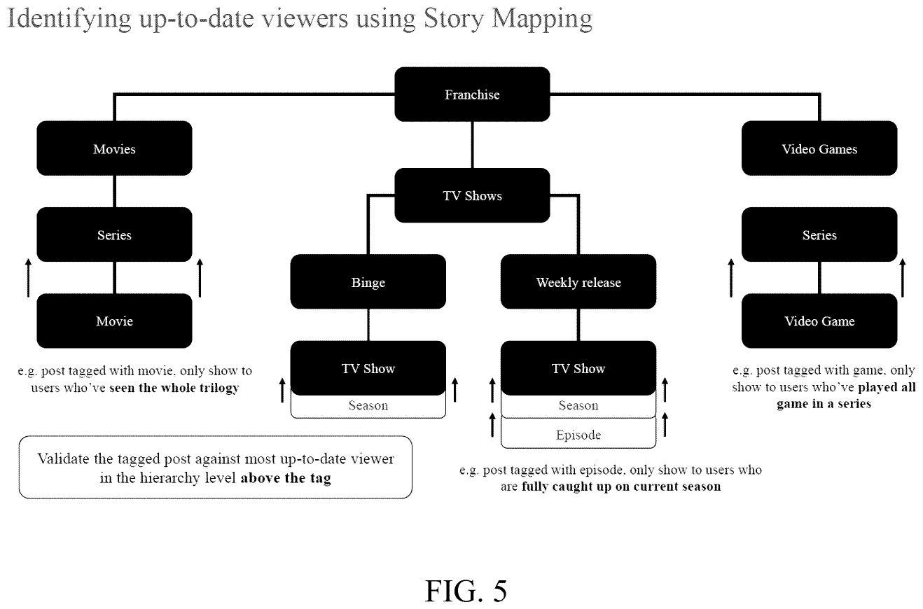

According to an embodiment shown in FIG. 5, validation engine 160 is configured to validate several types of data, including (i) untagged posts with ‘potential’ keywords; (ii) season and/or episode selection related content after the first week of release; and (iii) adaptations (e.g. manga to anime, movie to game). The validation process involves validating the tagged post against the most up-to-date viewer in the hierarchy level above the tag. For example, (i) testing the post amongst the users who have seen the whole trilogy; (ii) testing the post amongst users are fully caught up on current season; and (iii) testing the post amongst users who have played all the games in a series.

Validation engine 160 is configured to allow ‘uncertain’ spoiler posts in the recommendation feed without ruining the experience for blockers. This means the recommendation system for ‘uncertain’ spoilers is limited to users that are fully caught up on a series. Going up one level in the data structure defined by story map engine 110 is used to determine which users are fully caught up. For example, assessing an ‘uncertain’ episode-level spoiler means we need to check which users have seen the entire TV show. Similarly, an ‘uncertain’ spoiler for a movie means we need to check which users have seen the whole series.

The process of validation is used to configure the data structure defined by story map engine 110. For example, if a Creator had the keywords “Tony Stark” in a post and refused to tag with the correct movie, simply detecting the character name would not help determine if the right movie tag should be Iron Man 1, 2, or 3 as Tony Stark appears in all of them. This is an example of a recurring keyword, as further depicted in FIG. 10. Through the validation process, users who have seen the entire trilogy would received this aforementioned post, and consequently, be prompted to tag the media with the relevant tag. During the validation process, all Blockers across the series will not be able to view the suspected spoiler. For example, a user who has viewed Iron Man 1 and 2, but has blocked Iron Man 3, will not see the suspected spoiler, as there is a risk the post could be an Iron Man 3 spoiler.

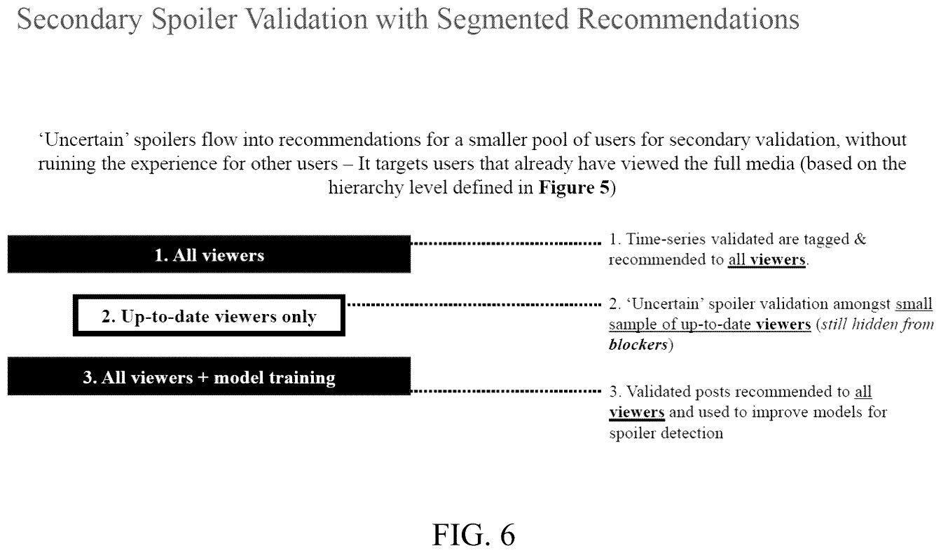

According to embodiments shown in FIGS. 6 to 9, the validation engine 160 is comprised of mechanisms, also known as, layers. The validation engine 160 has three layers.

The first layer involves time-stamping narrative-based media content posts. For example, for a given TV show, posts that are created and tagged in the same week as the release of a particular episode of the TV show, are shown and recommended to all viewers. The posts containing the previous episode tag will be identified and considered a potential spoiler (known as, “uncertain spoiler”) and consequently, will undergo a validation process.

The second layer involves validating the ‘uncertain’ spoilers amongst a small sample of up-to-date viewers still blocked from blockers. Examples of ‘uncertain’ spoilers may include untagged posts with ‘potential’ keywords; season and/or episode selection after the first week of release; and adaptations (e.g. manga to anime). The second layer involves showing the ‘uncertain’ spoilers to up-to-date viewers who have already experienced the media, and who are able identify mis-tagged and/or untagged posts. Up-to-date viewers who have successfully identified mis-tags in the past are prioritized in this group. Consequently, at the end of this layer, the following ‘uncertain’ spoiler categories are identified as ‘certain’ spoilers, namely, untagged posts with ‘potential’ keywords are now tagged with ‘confirmed’ keyword; season and/or episode tag is accurate and allows for granular blocking; and the source material that is common to the different media types in question, for example, manga to anime, and game to movie/TV show (e.g. TLOU).

The third layer involves the use of validated content to train natural language processing (NLP) models for improved future spoiler detection. The third layer involves feeding validated posts with the correct tags back into the system, issuing repeat users who mis-tagged posts a warning or in some cases, banning the user.

According to embodiments shown in FIGS. 1 to 9, spoiler blocking platform 100 may be integrated into a social media platform to allow users to browse social media platforms without the risk of encountering spoilers. The recommendation module serves to match users' asynchronous consumption of narrative-based media. For example, the spoiler posts are only shown after the spoiler is tagged as ‘seen’, allowing users to engage in the initial reactions to the relevant narrative-based media content and/or socially interact with users of the same preferences. Consequently, spoiler blocking platform 100 allows for a longer tail for consumption of media, and users can engage with others who watch on a similar schedule.

FIG. 11 shows an example process for an example spoiler blocking platform 100 implemented as a browser extension, according to some embodiments. For example, the browser extension is configured with a button for blocking spoilers for a particular title entity. Upon selection by a user, keywords associated with the title entity are extracted from the data structure(s) defined by story mapping engine 110 and stored in the user's cache. Conversely, when a user has seen a title entity that was previously blocked, the user can engage with a button presented by the browser extension for specifying that the user has viewed the media associated with the title entity, and recommendation engine 150 is configured to transmit previously blocked content containing spoilers to the user, and the associated keywords are removed from the user's cache. Any web element (content) containing keywords from the user cache are blocked with a spoiler warning.

Various embodiments of the invention have been described in detail. Since changes in and or additions to the above-described best mode may be made.

What is claimed is:

1. A computer-implemented method for spoiler blocking, the method comprising:
defining at least one data structure representing at least one keyword;
associating at least one tag with at least one content; and
preventing at least one content tagged with at least one spoiler from being presented to a user, using the at least one data structure.

2. The computer-implemented method of claim 1, further comprising marking at least one keyword as seen for at least one user.

3. The computer-implemented method of claim 1, further comprising managing the presentation of content recommended to at least one user.

4. The computer-implemented method of claim 1, further comprising validating at least one tag for at least one content.

5. A non-transitory computer readable medium storing a set of machine-interpretable instructions, which, when executed, cause a processor to perform a method for spoiler blocking, the method comprising:
defining at least one data structure representing at least one keyword;
associating at least one tag with at least one content; and
preventing at least one content tagged with at least one spoiler from being presented to a user, using the at least one data structure.

6. The computer-implemented method of claim 5, the method further comprising marking at least one keyword as seen for at least one user.

7. The computer-implemented method of claim 5, the method further comprising managing the presentation of content recommended to at least one user.

8. The computer-implemented method of claim 5, the method further comprising validating at least one tag for at least one content.

9. A method of identifying and filtering spoilers from narrative-based media, comprising:
adding a primary tag to narrative-based media data by a first user;
adding a secondary tag to narrative-based media data by a second user;
validating the narrative-based media data associated with a secondary tag; and
organizing the primary tags and secondary tags into a hierarchy.

10. The method of claim 9, wherein the hierarchy is comprised of groups and subgroups.

11. The method of claim 10, wherein the groups are known as title groups, and wherein the subgroups may be title entities or sub-title entities or name entities.

12. The method of claim 9, wherein the primary tag is known as a hard tag and the secondary tag is known as a soft tag.

13. The method of claim 9, wherein the validation of the narrative-based media data associated with a secondary tag is comprised of three sub-processes.
